(19) United States
(12) Patent Application Publication
(10) Pub. No.: US 2007/0103079 A1
(43) Pub. Date: May 10, 2007

(54) Plasma display panel

(76) Inventor: Kunio Takayama, Yongin-si (KR)

Correspondence Address: CHRISTIE, PARKER & HALE, LLP, PO BOX 7068, PASADENA, CA, 91109-7068, US

(21) Appl. No.: 11/593,688

(22) Filed: Nov. 6, 2006

(30) Foreign Application Priority Data
Nov. 8, 2005 (KR) 10-2005-0106351

(51) Int. Cl. H01J 17/02

(52) U.S. Cl. 313/610

(57) ABSTRACT

A plasma display panel capable of reducing power consumption by lowering address discharge voltage and electrostatic capacitance among electrodes. The plasma display panel includes a front and a rear substrate facing each other; barrier ribs which are located on the rear substrate to define discharge cells; phosphor layers formed on the inner sides of the discharge cells; an intermediate substrate located over the barrier ribs; spacers located between the front and intermediate substrates; address electrodes which are formed on the intermediate substrate and sustain and scan electrodes which are formed on the front substrate along a direction crossing the direction of the address electrodes. A space between the front and intermediate substrates is under vacuum or filled with a fluid having a low permittivity in order to keep the address discharge voltage between the electrodes low.

### CROSS-REFERENCE TO RELATED APPLICATION

This application claims priority to and the benefit of Korean Patent Application No. 10-2005-0106351 filed in the Korean Intellectual Property Office on Nov. 8, 2005, the entire content of which is incorporated herein by reference.

### BACKGROUND OF THE INVENTION

1. Field of the Invention

The present invention relates to a plasma display panel, and more particularly, to a plasma display panel having address electrodes, sustain electrodes, and scan electrodes which reduce power consumption.

2. Description of the Related Art

Plasma display panels (PDPs) display an image typically by using a gas discharge. The PDPs have excellent display capacity, brightness, contrast, viewing angle, and latent image reduction.

In a PDP, a front substrate, which has sustain electrodes and scan electrodes with barrier ribs interposed therebetween, is sealed against a rear substrate having address electrodes. The barrier ribs define discharge cells. An inert gas (e.g. neon (Ne) and xenon (Xe)) is filled in the discharge cells.

When an address voltage is supplied to the address electrodes, and a scan pulse is supplied to the scan electrodes, the PDP produces wall charges between the two electrodes, and selects the discharge cells to be turned on by an address discharge. In this state, when a sustain pulse is supplied to the sustain electrodes and the scan electrodes, gaseous ions formed in the discharge cells travel between the sustain electrodes and the scan electrodes carrying electrons from one electrode to the other. Accordingly, the address voltage is added to a wall voltage stemming from the wall charges formed by the address discharge. Thus, the address voltage exceeds a discharge ignition voltage, thereby generating a sustain discharge within the selected discharge cells.

A vacuum ultraviolet ray generated within the discharge cells by the sustain discharge excites a phosphor material coating inner surface of the discharge cells. The phosphor material relaxes from the excited state, and thus generates a visible light beam. Accordingly, an image is formed on the PDP.

Since the PDP has the address electrodes on the rear substrate, and the sustain electrodes and the scan electrodes on the front substrate, the distance between the address electrodes and the scan electrodes increases, thereby disadvantageously raising an address discharge voltage.

In order to reduce the address discharge voltage, in one type of PDP the sustain, scan, and address electrodes are all located on a front substrate.

In this type of PDP, the sustain electrodes and the scan electrodes are covered with a dielectric layer, and the address electrodes are formed over the dielectric layer. High permittivity of the dielectric layer raises electrostatic capacitance among the sustain electrodes, the scan electrodes, and the address electrodes, thereby disadvantageously increasing power consumption.

### SUMMARY OF THE INVENTION

The embodiments of the present invention provide a plasma display panel capable of lowering an address discharge voltage.

The embodiments of the present invention also provide a plasma display panel capable of decreasing electrostatic capacitance among electrodes, thereby reducing power consumption.

According to one aspect of the present invention, a plasma display panel is provided having a first substrate and a second substrate facing each other, barrier ribs which are located on the first substrate to define discharge cells, phosphor layers formed on the inner sides of the discharge cells, a third substrate located on the barrier ribs, spacers located between the second substrate and the third substrate, address electrodes which are formed on the third substrate in a first direction, and correspond to the discharge cells, and first electrodes and second electrodes which are formed on the second substrate in a second direction crossing the first direction, and correspond to the discharge cells.

The spacers may be located in the second direction corresponding to a boundary position of the discharge cells that are adjacent one another in the first direction. The spacers may be formed of a glass bead. The spacers may be formed of the same material as the third substrate or etched from the substrate.

A vacuum space may be formed between the second substrate and the third substrate. The space between the second and third substrates may be formed using the spacers. The space may be filled with a fluid between the second substrate and the third substrate. The fluid may be an inert gas. The fluid may be a liquid material.

The third substrate may be formed of a transparent glass. The address electrodes may be formed on one surface of the third substrate facing the first substrate.

Each address electrode may include an extended portion which extends in the first direction corresponding to a boundary position of the discharge cells neighboring in the second direction, and a protruded portion which protrudes towards the inner part of the discharge cells in the second direction. The extended portion may be formed of metal, and the protruded portion may be formed of a transparent ITO (Indium tin oxide). The address electrodes may be covered with a dielectric layer. In addition, the dielectric layer may be covered with a protection layer.

The first electrode and the second electrode may each include transparent electrodes formed on the second substrate corresponding to the discharge cells, and bus electrodes connecting the transparent electrodes in the second direction.

The barrier ribs may include first barrier members which are formed on the first substrate to extend in the first direction. The barrier ribs may further include second barrier members which are formed between the first barrier members to extend in the second direction.

### BRIEF DESCRIPTION OF THE DRAWINGS

FIG. 1 is a perspective exploded view schematically showing a plasma display panel (PDP) according to a first embodiment of the present invention.

FIG. 2 is a plan view showing the relationship between layouts of barrier ribs and electrodes of FIG. 1.

FIG. 3 is a cross-sectional view taken along line III-III of FIG. 1.

FIG. 4 is a cross-sectional view showing a PDP according to a second embodiment of the present invention.

FIG. 5 is a plan view of a PDP according to a third embodiment of the present invention.

### DETAILED DESCRIPTION

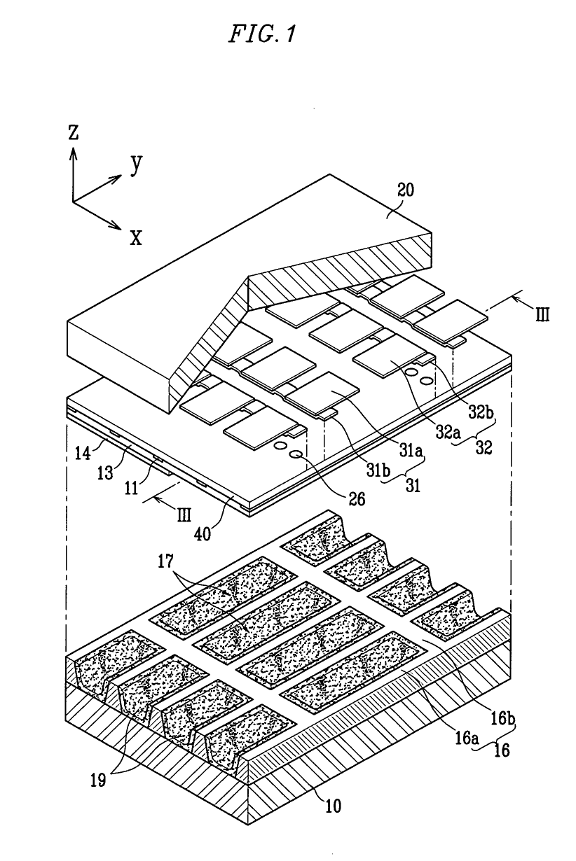

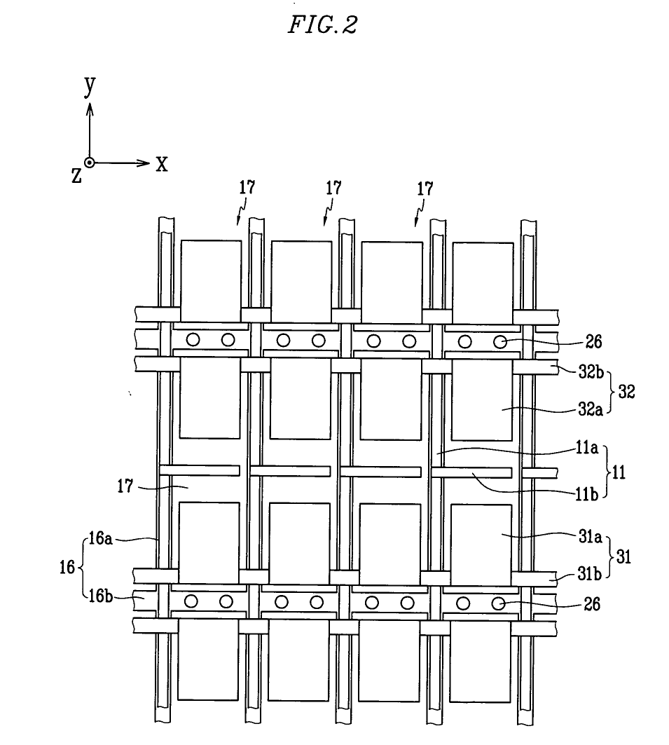

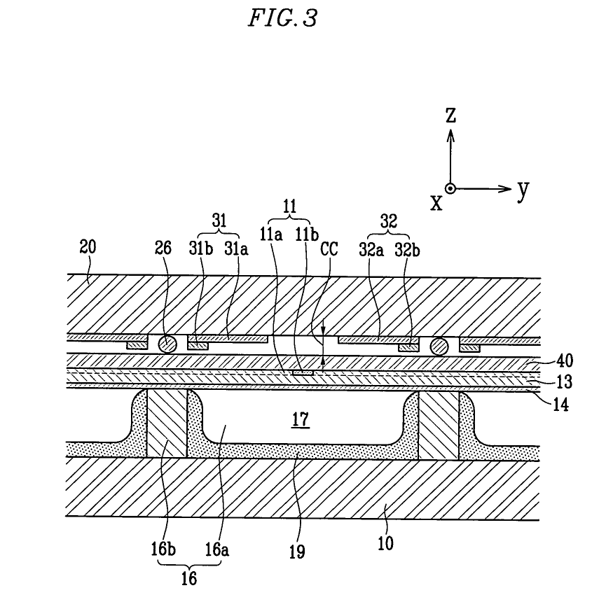

Referring to FIG. 1, FIG. 2, and FIG. 3, the PDP of the first embodiment of the present invention includes a first substrate 10 (hereinafter referred to as a “rear substrate”) and a second substrate 20 (hereinafter referred to as a “front substrate”). The rear and front substrates 10, 20, face each other and are sealed against each other while being spaced apart.

A third substrate 40 (hereinafter referred to as a “intermediate substrate”) is located between the rear substrate 10 and the front substrate 20. Barrier ribs 16 are located between the rear substrate 10 and the intermediate substrate 40. Spacers 26 are located between the intermediate substrate 40 and the front substrate 20.

The barrier ribs 16 that are located between the rear substrate 10 and the intermediate substrate 40 have predetermined heights to define a plurality of discharge cells 17. The discharge cells 17 are filled with a discharge gas (for example, a gas mixture including neon (Ne) and xenon (Xe)) to generate vacuum ultraviolet rays through gas discharge. The discharge cells 17 include phosphor layers 19 which absorb the vacuum ultraviolet ray to emit visible light.

To form an image by gas discharge, the PDP includes address electrodes 11 respectively corresponding to the discharge cells 17, and first electrodes 31 (hereinafter referred as “sustain electrodes”), and second electrodes 32 (hereinafter referred to as “scan electrodes”).

The address electrodes 11 are formed on the intermediate substrate 40 to extend in a first direction (y-axis direction in the drawings, hereinafter referred to as “y”). Each address electrode 11 corresponds to the discharge cells 17 that are adjacent one another and formed along the first direction y. The address electrodes 11 are parallel to one another and two adjacent address electrodes 11 correspond to two rows of discharge cells 17 neighboring in a second direction (x-axis direction in the drawing, hereinafter referred to as “x”) crossing the first direction y.

Each of the address electrodes 11 includes an extended portion 11a and a protruded portion 11b. The extended portion 11a extends in the first direction y corresponding to a boundary between the discharge cells 17 neighboring in the second direction x. The extended portion 11a is located in a non-emissive region of the discharge cell 17, thereby not interfering with a forward emission of the visible light beam toward the front substrate 20. The extended portion 11a may be formed of metal having an excellent conductivity, for example, aluminum (Al). The protruded portion 11b protrudes from the extended portion 11 a towards the inner part of the discharge cell 17 in the second direction x. The protruded portion 11b is therefore located in an emissive region of the discharge cell 17. In order to minimize blockage of the visible light beam, the protruded portion 11b may be formed of a transparent material, for example, ITO (indium tin oxide).

As described above, the address electrodes 11 are formed on one surface of the intermediate substrate 40, for example, a surface facing the rear substrate 10. The address electrodes 11 are covered with a dielectric layer 13. During discharge, the dielectric layer 13 protects the address electrodes 11 against a direct collision with positive ions or electrons, thereby reducing damage to the address electrodes 11. Further, the dielectric layer 13 accumulates wall charges.

The dielectric layer 13 is covered with a protection layer 14. The protection layer 14 is formed of a transparent MgO, thereby transmitting a visible light beam. The protection layer 14 protects the dielectric layer 13 against discharge, and increases a secondary electron emission factor to reduce a discharge ignition voltage during discharge.

To permit the forward transmission of the visible light beam emitted from the discharge cells 17, the intermediate substrate 40 is formed of a transparent material such as glass like the front substrate 20.

The barrier ribs 16 are located between the intermediate substrate 40, where the address electrodes 11 are formed, and the rear substrate 10. For example, the barrier ribs 16 are formed with first barrier members 16a extending in the first direction y and second barrier members 16b extending in the second direction x. The second barrier members 16b are located between each two neighboring first barrier members 16a, and are arranged in the second direction x crossing the first barrier members 16a.

As described above, the first barrier members 16a and the second barrier members 16b cross each other between the rear substrate 10 and the intermediate substrate 40. Accordingly, each discharge cell 17 is enclosed between the two substrates with two sets of intersecting first and second barrier members 16a and 16b. The closed barrier structure around a discharge cell 17 effectively prevents cross-talk between the discharge cells.

The closed barrier structure is not limited to a rectangular parallelepiped shape as shown in the drawing. Thus, variations in shape may be made to obtain another shape such as a hexagonal prism or an octagonal prism.

The phosphor layers 19 are formed on the lateral sides of the barrier ribs 16 and the surface of the rear substrate 10 surrounded by the barrier ribs 16. That is, the phosphor layers 19 are formed on the lateral sides of the first barrier members 16a, the lateral sides of the second barrier members 16b, and the surface of the rear substrate 10 that is surrounded by these barrier members.

The sustain electrodes 31 and the scan electrodes 32 are formed on the inner surface of the front substrate 20 facing the discharge cells 17. The sustain electrodes 31 and the scan electrodes 32 form a surface discharge structure. The sustain electrodes 31 and the scan electrodes 32 are arranged extending in the second direction x crossing the direction y of the address electrodes 11.

The sustain and scan electrodes 31, 32 are formed each with a respective transparent electrode 31a, 32a and a respective bus electrode 31b, 32b. The transparent electrodes 31a, 32a protrude towards the center of the discharge cells 17, and form a surface discharge structure. To supply voltage to the transparent electrodes 31a, 32a, the bus electrodes 31b, 32b are formed on the transparent electrodes 31a, 32a to extend in the second direction x.

In an alternative embodiment, the transparent electrodes 31a, 32a may extend in the second direction x like the bus electrodes 31b, 32b (not shown).

The transparent electrodes 31a, 32a produce a surface discharge within the discharge cells 17. In order to ensure an adequate aperture ratio for the discharge cells 17, the transparent electrodes 31a, 32a are formed of a transparent material, for example, ITO (Indium tin oxide). The bus electrodes 31b, 32b are formed of metal having an excellent conductivity, so as to ensure conductivity by compensating for high electrical resistance of the transparent electrodes 31a, 32a.

In the first embodiment that is described above, the address electrodes 11 are formed on the intermediate substrate 40 facing the rear substrate 10, and the sustain electrodes 31 and the scan electrodes 32 are formed on the front substrate 20.

However, the present invention is not limited to the above-mentioned layout, and thus the locations of the address electrodes 11, the sustain electrodes 31, and the scan electrodes 32 may change from one embodiment to the other. For example, the sustain electrodes 31 and the scan electrodes 32 may be formed on the intermediate substrate 40, and the address electrodes 11 may be formed on the front substrate 20.

The spacers 26 are interposed between the intermediate substrate 40 and the front substrate 20, and form a predetermined gap CC between the intermediate substrate 40 and the front substrate 20 (see FIG. 3). The spacer 26 may be formed of a glass bead. The spacers 26 are located along the second direction x corresponding to a boundary of the neighboring discharge cells 17 (see FIG. 2).

That is, the spacers 26 are located between the bus electrodes 31b of the sustain electrodes 31 and the bus electrodes 32b of the scan electrodes 32, and remain parallel to these bus electrodes 31b, 32b. Therefore, the spacers 26 are located at locations corresponding to the second barrier members 16b of the barrier ribs 16 that in turn correspond to non-emissive regions.

The spacers 26 may be formed by etching one surface of the intermediate substrate 40. In this case, the spacers 26 are formed of the same material as the intermediate substrate 40.

A space is formed between the front substrate 20 and the intermediate substrate 40 by the spacers 26. A substantial vacuum is established in this space. Thus, the sustain electrodes 31 and the scan electrodes 32 are covered with a vacuum insulation layer having a relative permittivity ε of 1. In one embodiment, the space between the front substrate 20 and the intermediate substrate 40 has the same vacuum pressure as the interior of the discharge cell 17 formed between the intermediate substrate 40 and the rear substrate 10.

For example, if it is assumed that a discharge gap formed between the sustain electrode 31 and the scan electrode 32 is 100-200 μm at a discharge ignition voltage of 400-600V, and a dielectric breakdown voltage of air is 3(V/μm), then if the space between the front and intermediate substrates 20, 40 is not under vacuum, discharge does not occur in the space between the front substrate 20 and the intermediate substrate 40. Instead, discharge first occurs in the discharge cells 17 between the intermediate substrate 40 and the rear substrate 10 where a vacuum has been established.

The spacers 26 allow the gap CC to be formed between the front substrate 20 and the intermediate substrate 40. This gap may be under vacuum and has a lower permittivity than a dielectric layer that would have been there if the spacers were not being used. As a result the permittivity between the address electrode 11 and the scan electrode 32 is reduced thereby enabling an address discharge at a lower voltage. Further, having the intermediate substrate 40 between the front and rear substrates 20, 10 and forming the address electrodes on the intermediate substrates 40, as opposed to the rear substrate, allows a reduced distance between the address electrodes and the sustain and scan electrodes which also helps reduce the address discharge voltage.

Due to the spacers 26, a vacuum space is formed between the sustain electrodes 31, the scan electrodes 32, and the address electrodes 11 that has a permittivity ε of 1, lower than the permittivity of other dielectric materials. Thus, power consumption between electrodes are reduced in comparison with the case that additional dielectric layer is provided.

In the PDP configured as described above, a reset discharge occurs during a reset period in response to a reset pulse supplied to the scan electrodes 31. An address discharge then occurs during an addressing period following the reset period in response to a scan pulse supplied to the scan electrodes 32 and an address pulse supplied to the address electrodes 11. Thereafter, a sustain discharge occurs during a sustain period in response to a sustain pulse supplied to the sustain electrodes 31 and the scan electrodes 32.

The sustain electrodes 31 and the scan electrodes 32 function as electrodes for supplying the sustain pulse required for the sustain discharge. The scan electrodes 32 function as electrodes for supplying the reset pulse and the scan pulse. The address electrodes 11 function as electrodes for supplying the address pulse. Functions of these electrodes 31, 32, 11 may be different according to waveforms of voltages respectively supplied thereto. Thus, the present invention is not limited to the aforementioned functions.

In the PDP, the discharge cells 17 are selected to be turned on by the address discharge stemming from the interaction of the address electrodes 11 and the scan electrodes 32. The selected discharge cells 17 are driven while the sustain discharge occurs due to the interaction of the sustain electrodes 31 and the scan electrodes 32. As a result, an image is formed.

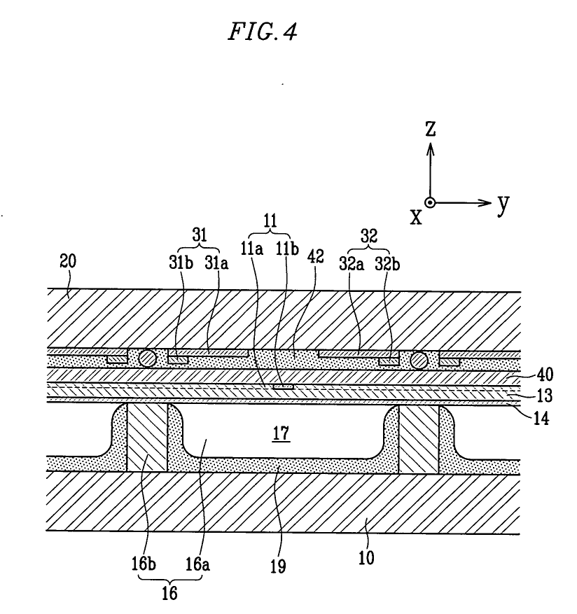

FIG. 4 is a cross-sectional view of a PDP according to a second embodiment of the present invention.

The second embodiment is similar to the first embodiment in terms of overall structure and operations. Thus, description of like elements is omitted.

As described above, the space between the front substrate 20 and the intermediate substrate 40 is under a substantial vacuum in the first embodiment. However, according to the second embodiment, the space between the front substrate 20 and the intermediate substrate 40 is filled with a fluid 42. The fluid 42 electrically insulates the sustain electrodes 31 and the scan electrodes 32.

The fluid 42 exemplifies that although the space between the front substrate 20 and the intermediate substrate 40 may be under vacuum, the space may alternatively be formed with a fluid dielectric layer different from the conventional solid dielectric layer. That is, an inert gas having a high breakdown voltage may be filled in this space. For example, the space may be filled with a gas containing Xe. In this case, the Xe contained in the gas has a partial pressure that is different from the partial pressure of Xe in a discharge gas injected within a discharge cell. A fluid 42 may be a liquid material. The liquid material may have a high working voltage. The dielectric oil generally used in a capacitor or a transformer may be used as the liquid material. Silicon oil may also be used because it has a high working voltage, low permittivity and because it is transparent. In addition, Dimethyl silicon oil having the following molecular formula may be used.

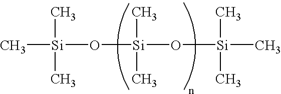

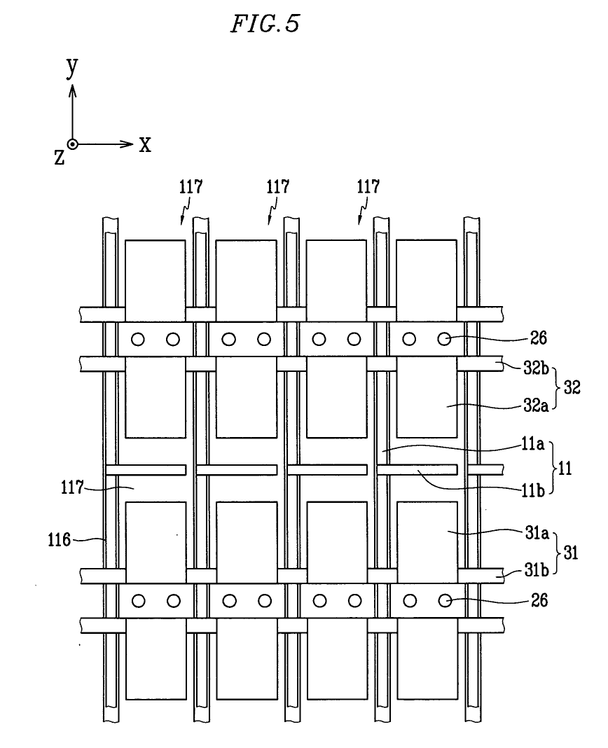

FIG. 5 is a plan view of a PDP according to a third embodiment of the present invention.

The third embodiment is similar to the first embodiment. However, the barrier ribs 116 of the third embodiment do not include first and second barrier members 16a, 16b of the first embodiment. In the third embodiment, the barrier ribs 116 are similar to the first barrier members 16a of the first embodiment and extend in one direction alone.

The barrier ribs 116 extend in the first direction y between the rear substrate 10 and the intermediate substrate 40, and are parallel to one another and spaced apart along the second direction x. Accordingly, the barrier ribs 116 form an open-type barrier structure. Discharge cells 117 of the third embodiment, are enclosed only along one direction y.

In the third embodiment, the sustain electrodes 31 and the scan electrodes 32 are located on the front substrate 20, and the address electrodes 11 are located on the intermediate substrate 40. This arrangement indicates that various barrier ribs can be located between the intermediate substrate 40 and the rear substrate 10.

In a plasma display panel according to the embodiments of the present invention, an intermediate substrate is located between a rear substrate and a front substrate. Address electrodes are formed on the intermediate substrate. Sustain electrodes and scan electrodes are formed on the front substrate. A space between the front substrate and the intermediate substrate may be under vacuum or may be filled with liquid. Thus, the distance between the scan electrodes and the address electrodes is reduced, thereby lowering an address discharge voltage. The vacuum or fluid-filled space between electrodes results in a low permittivity. Thus, electrostatic capacitance decreases, thereby advantageously reducing power consumption.

Although certain exemplary embodiments of the present invention have been shown and described, the present invention is not limited to the described embodiments, but may be modified in various forms without departing from the scope of the invention set forth in the detailed description, the accompanying drawings, the appended claims, and their equivalents.

What is claimed is:

1. A plasma display panel comprising:
a first substrate;
a second substrate facing the first substrate;
barrier ribs located on the first substrate to define discharge cells;
phosphor layers formed on inner surfaces of the discharge cells;
a third substrate located between the first substrate and the second substrate and over the barrier ribs;
spacers located between the second substrate and the third substrate;
address electrodes formed on the third substrate along a first direction and corresponding to the discharge cells; and
first electrodes and second electrodes formed on the second substrate along a second direction crossing the first direction and corresponding to the discharge cells.

2. The plasma display panel of claim 1, wherein the spacers are located along the second direction corresponding to a boundary between the discharge cells neighboring in the first direction.

3. The plasma display panel of claim 1, wherein a substantial vacuum is formed between the second substrate and the third substrate.

4. The plasma display panel of claim 1, wherein a fluid is filled between the second substrate and the third substrate.

5. The plasma display panel of claim 4, wherein the fluid is an inert gas.

6. The plasma display panel of claim 4, wherein the fluid is a liquid material.

7. The plasma display panel of claim 4, wherein the fluid is Dimethyl silicon oil.

8. The plasma display panel of claim 1, wherein the spacers are formed from glass beads.

9. The plasma display panel of claim 1, wherein the spacers are etched from the third substrate.

10. The plasma display panel of claim 1, wherein the third substrate is a transparent glass.

11. The plasma display panel of claim 1, wherein the address electrodes are formed on one surface of the third substrate facing the first substrate.

12. The plasma display panel of claim 11, wherein each address electrode includes:
an extended portion extending in the first direction corresponding to a boundary position of the discharge cells neighboring in the second direction; and
a protruded portion protruding in the second direction towards the inner part of the discharge cells.

13. The plasma display panel of claim 12, wherein the extended portion is metal, and the protruded portion is transparent ITO.

14. The plasma display panel of claim 11, wherein a dielectric layer is formed over the address electrodes.

15. The plasma display panel of claim 14, wherein a protection layer is formed over the dielectric layer.

16. The plasma display panel of claim 1, wherein the first electrode and the second electrode each include:
transparent electrodes corresponding to the discharge cells; and
bus electrodes connecting the transparent electrodes in the second direction.

17. The plasma display panel of claim 1, wherein the barrier ribs include first barrier members formed on the first substrate and extending in the first direction.

18. The plasma display panel of claim 17, wherein the barrier ribs further include second barrier members formed between the first barrier members and extending in the second direction.
